(19) United States
(12) Patent Application Publication
(10) Pub. No.: US 2015/0379649 A1
(43) Pub. Date: Dec. 31, 2015

(54) TECHNIQUES FOR MANAGING RETAIL SERVICES

(71) Applicants: Kimberly Denise Sullivan, Grapevine, TX (US); Erika Thomas, Frisco, TX (US); Kirstin Sue Martin, Laguna Beach, CA (US); Jennifer Shea Lyle, Grapevine, TX (US)

(72) Inventors: Kimberly Denise Sullivan, Grapevine, TX (US); Erika Thomas, Frisco, TX (US); Kirstin Sue Martin, Laguna Beach, CA (US); Jennifer Shea Lyle, Grapevine, TX (US)

(21) Appl. No.: 14/317,462

(22) Filed: Jun. 27, 2014

(51) Int. Cl. G06Q 50/12; G06Q 10/06

(52) U.S. Cl. CPC G06Q 50/12; G06Q 10/063112

(57) ABSTRACT

Historical and real-time metric data is captured for a retail establishment. When a customer comes for service at the retail establishment, a real-time suggestion as to what service location and what service personnel should be assigned to that customer based on evaluation of the metric data.

### BACKGROUND

Restaurants rely on their hosts to know which table they should seat guests at. Although some automated solutions provide a suggested seating solution for a patron, the present approaches only take into account things like party size, server capacity, and server rotation. The restaurant still has to rely on the host to understand who the best servers are so that the restaurant can effectively seat priority guests with the better servers.

For example, if a Very Important Person (VIP) guest comes into the restaurant, the restaurant owner would likely want to seat the VIP guest with the owner's best server. The host, after recognizing that the guest is a VIP guest, must know that a particular waiter is the best server so that the host can seat the VIP guest in that waiter's section.

In addition, the better servers should be assigned to the better stations. Restaurants rely on the manager to assign servers to stations for each service. This situation can lead to lower performing servers being assigned to better stations (those with a better location or those bringing in higher profits).

Therefore, there is a need for improved management of retail services.

### SUMMARY

In various embodiments, techniques for managing retail services are presented. According to an embodiment, a method for managing retail services is provided.

Specifically, at least one metric relevant to a state of a retail establishment is obtained. Next, a service location for a customer and/or a service person to assist the customer are suggested based on evaluation of the at least one metric. Finally, the service location and/or an identifier for the service person are presented in a screen rendered on a display.

### BRIEF DESCRIPTION OF THE DRAWINGS

FIG. 1 is a diagram of a retail service system for practicing management of retail services, according to an example embodiment.

FIG. 2 is a diagram of a method for managing retail services, according to an example embodiment.

FIG. 3 is a diagram of another method for managing retail services, according to an example embodiment.

FIG. 4 is a diagram of a retail management system, according to an example embodiment.

### DETAILED DESCRIPTION

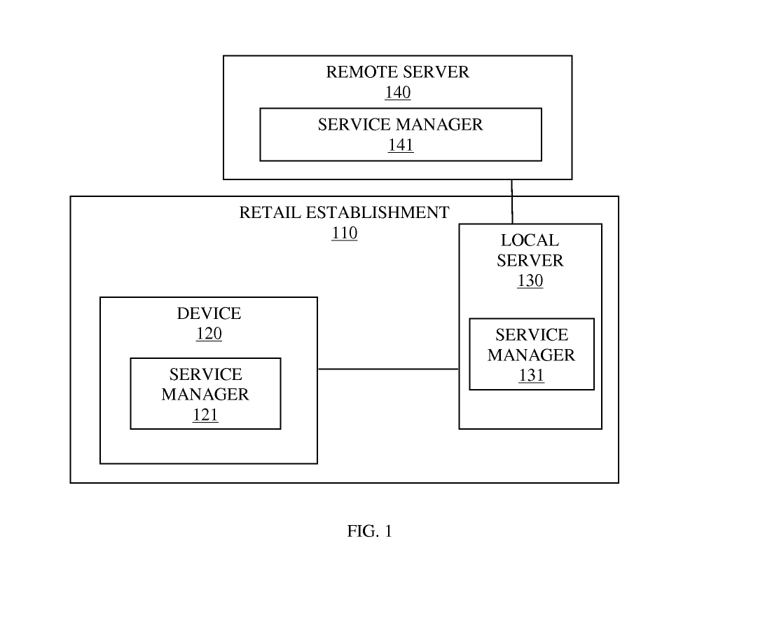

FIG. 1 is a diagram of a retail service system for practicing management of retail services, according to an example embodiment. The components of the retail service system are shown in greatly simplified form with only those components shown necessary for the understanding of the various embodiments of the invention.

The retail service system includes a retail establishment 110 and, optionally a remote server 140. The retail establishment 110 includes at least one device 120, which may optionally, include a service manager 121; the retail establishment 110 may also, optionally include a local server 130, which optionally includes a service manager 131. The optional remote server 140 may optionally include a service manager 141.

It is to be noted that to avoid the different usages of the word “server” herein, where one usage refers to a computer server and another usage refers to a waiter that is a server, the latter usage will use the term “waiter” and the former “server” in the computing sense.

It is noted that the service managers 121, 131, and 141 can exist as different executing instances on the device 120, the local server 130, and the remote server 140 (when present). In some cases, just one instance of a service manager 121, 131, or 141 exists. In some cases, just two different executing instances of the service manager 121, 131, and/or 141 exist.

In an embodiment, the device 120 is a terminal device operated by personnel of the retail establishment 110.

In an embodiment, the device 120 is a Point-Of-Sale (POS) device operated by personnel of the retail establishment 110.

In an embodiment, the device 120 is a self-service kiosk operated by guests or customers of the retail establishment 110.

In an embodiment, the device 120 is a tablet operated by personnel of the retail establishment 110.

In an embodiment, the device 120 is a smart phone operated by personnel of the retail establishment 110.

In an embodiment, the device 120 is a smart phone operated by customers of the retail establishment 110.

In an embodiment, the device 120 is a wearable processing device (such as GOOGLE GLASS™ or a smart watch) operated by personnel of the retail establishment 110 or customers of the retail establishment 110.

The retail establishment 110 maintains data collected for operations of the retail establishment 110. Some of this data includes metrics, such as, but not limited to: names of customers, loyalty accounts for customers, transaction histories for customers, preferences of the customers, waiter identifications for waiters, average revenue for each waiter, a revenue ranking for each waiter, a quality rating for each waiter, service locations (such as tables at a restaurant), current waiter to section assignments, current load for each waiter, and the like. The data can be historical and collected in real time while the retail establishment is in operation with customers and waiters.

The data permits the service manager 121, 131, and/or 141 to make intelligent decisions about assignments of waiters to service locations and customers to service locations and/or waiters.

When a guest enters the restaurant, the host accesses the service manager 121, 131, or 141 from the device 120. The service manager 121, 131, or 141 accesses the retail establishment's metrics (historical and live data as discussed above) for the retail establishment 120 to determine which wait staff are currently scheduled and present at the retail establishment 110, the performance (revenue and quality) for each waiter, waiter rotation, party size, and waiter capacity to determine which table to suggest when seating the guests. In some cases, the quality of the guest (e.g., frequent guest, annual amount spent by the guest, first time guest, etc.) and quality of the table can be used in the metrics as well. So, better waiters may get assigned to better table sections, but within those sections there may be better tables. So, a VIP guest that spends a lot of money annually with the retail establishment 110 may be automatically seated at the nest table in the retail establishment 110. This is but one example as others may exists as well, all of which are intended to fall within the generous scope of the embodiments presented herein.

The service manager 121, 131, and/or 141 also knows the station ranking (another type of ranking) so the better waiters are able to be assigned to the better stations. Thereby further improving the guest's experience.

Station assignments can be done automatically by the service manager 121, 131, and/or 141 based on the wait staff schedules, wait staff rankings, and station rankings. Better stations may include those that have window views or are far from the bathrooms and the kitchen or those which make the most money for the restaurant (retail establishment 120).

Possible scenarios may include:

A host recognizes a VIP guest and enters that information into the service manager 121 using the device 120 to obtain suggested seating. The service manager 121 suggests tables based on the best waiter currently available.

A non-VIP customer enters and the waiter uses the suggestion obtained from the service manager 121 to determine which table to seat the guest at. The service manager 121 may also suggest based on waiter quality+waiter rotation so that better waiters get more tables than lower performing waiters.

Waiter A (1st place in ranking)

Waiter B (2nd place in ranking)

Waiter C (3rd place in ranking)

Table assignments may be presented as follows: Waiter A, Waiter B, Waiter C; Waiter A, Waiter B; Waiter A, Waiter B, Waiter C. Waiter C gets skipped every other rotation indicating that Waiter C is the worst ranked Waiter.

Ranking of stations, server schedules and waiter performance are taken into account by the service manager 121, 131, and/or 141 when automatically assigning waiters to stations by the service manager 121.

Waiter A (1st place in ranking)

Waiter B (2nd place in ranking)

Waiter C (3rd place in ranking)

Station 1 (1st place in ranking)

Station 2 (2nd place in ranking)

Station 3 (3rd place in ranking)

Waiter A is automatically assigned to Station 1 by the service manager 121, 131, and/or 141 for dinner because Waiter A is the highest ranking server scheduled to work during that shift.

Waiter B is automatically assigned to Station 2 service manager 121, 131, and/or 141 for the dinner shift based on where Waiter B and Station 2 fall in the rankings.

Waiter C is automatically assigned to Station 3 service manager 121, 131, and/or 141 since Waiter C is the lowest performing server on shift and Station 3 is the lowest ranked station.

Selection of waiters and table assignments (service locations within the retail establishment 110) are based by the service manager 121, 131, and/or 141 evaluating the historical and real time data (metrics) for the retail establishment 110. This can be configured by the retail establishment 110 based on what the owner of the retail establishment 110 knows about his business customers and staff.

In an embodiment, the service manager 121, 131, and/or 141 include a front-end graphical user interface where configurations about decisions for suggested seating arrangements and suggested waiters can be identified by a user.

In an embodiment, the service manager 121, 131, and/or 141 is preconfigured to automatically resolve suggested seating arrangements and suggested waiter assignments.

In an embodiment, the suggested assignments to a waiter and a seating arrangement can be overridden by a user.

In an embodiment, the metrics (historical and real time data) can include for each waiter, a job code rating, revenue rating, per person metric (per person revenue average), customer specifically requesting a specific waiter, customer profile in a loyalty database that identifies waiters by customer provided ranking (may be acquired in the customer profile via surveys that the customer takes or may be an option in the customer's loyalty profile that the customer can activate), and the like.

It is also to be noted that the less traffic the retail establishment 110 has the better the service manager 121, 131, and/or 141 can suggest seating and waiter assignments. This is so because if the retail establishment 110 is at capacity when a VIP comes in for service, there are fewer options that can be selected to satisfy the VIP.

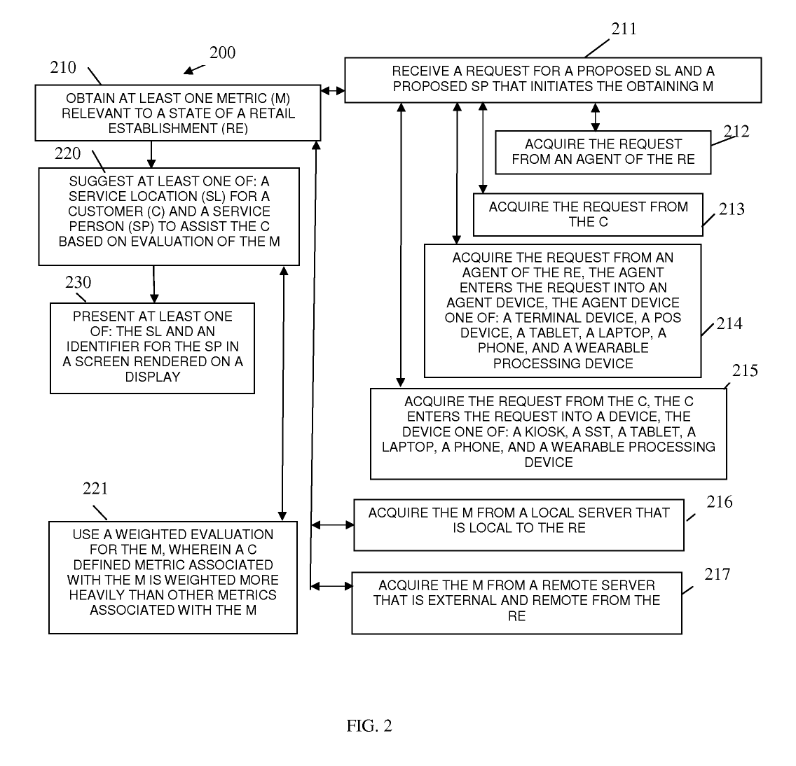

As presented above and below (with the discussions of the FIGS. 2-4), the techniques herein reduce the guesswork of a host trying to decide which table to seat a guest at in order to provide a more consistent experience for guests The techniques herein ensure priority guests are given the best waiters and the best tables to further enhance their experience. Moreover, the techniques herein enable the restaurant manager to reward high performance waiters with better station assignments and more seats.

It is noted that although the retail service system was discussed with reference to the operation of a restaurant, the invention is not so limited as any retail establishment can benefit from the approaches discussed herein, such as but not limited to: travel, banking, beauty or spa enterprises, and others.

The above-discussed embodiments and other embodiments are now presented with the discussions of the FIGS. 2-4.

FIG. 2 is a diagram of a method for managing retail services, according to an example embodiment. The method 200 (hereinafter “retail suggestion manager”) is implemented as instructions programmed and residing in memory or on a non-transitory computer-readable (processor-readable) storage medium and executed by one or more processors of a device. The processors are specifically configured and programmed to process the retail suggestion manager. The retail suggestion manager may also operate over one or more networks. The networks are wired, wireless, or a combination of wired and wireless.

In an embodiment, the retail suggestion manager is the service manager 121 of the FIG. 1.

In an embodiment, the retail suggestion manager is the service manager 131 of the FIG. 1.

In an embodiment, the retail suggestion manager is the service manager 141 of the FIG. 1.

In an embodiment, the retail suggestion manager is a combination of the service managers 121, 131, and 141 of the FIG. 1.

At 210, the retail suggestion manager obtains at least one metric relevant to a state of the retail establishment. Historical and real time data were discussed above as metrics. The state refers to the existing staff at the retail establishment on duty, service locations in use, service locations available for use, customers present at the retail establishment, and the like.

According to an embodiment, at 211, the retail suggestion manager receives a request for a proposed current service location and a proposed current service person; the request initiates the acquisition of the historical and real time metrics (or the at least one metric relevant to the state of the retail establishment).

In an embodiment of 211 and at 212, the retail suggestion manager acquires the request from an agent of the retail establishment, such as a host at a restaurant as was discussed above with reference to the FIG. 1.

In an embodiment of 211 and at 213, the retail suggestion manager acquires the request from a customer seeking service at the retail establishment.

So, the initiation of obtaining the at least one metric can come from an agent of the retail establishment or from a customer seeking service at the retail establishment.

In still another embodiment of 211 and at 214, the retail suggestion manager acquires the request from an agent of the retail establishment. The agent enters the request into an agent device, and the agent device is one of: a terminal device, a POS device, a tablet, a laptop, a phone, and a wearable processing device.

In yet another embodiment of 211 and at 215, the retail suggestion manager acquires the request from the customer. The customer enters the request into a device, and the device is one of: a kiosk, a SST, a tablet, a phone, and a wearable processing device.

In another case of 215, the customer indirectly provides the request when a kiosk users facial recognition to recognize the customer. So, the device can enter the request indirectly on behalf of the customer using facial recognition on the customer when the customer is situated in front of a camera interfaced to the device.

According to an embodiment, at 216, the retail suggestion manager acquires the at least one metric from a local server that is local to the retail establishment.

In another case, at 217, the retail suggestion manager acquires the at least one metric from a remote server that is external and remote from the retail establishment.

At 220, the retail suggestion manager suggests at least one of: a service location for a customer and a service person to assist the customer based on evaluation of the at least one metric.

In an embodiment, at 221, the retail suggestion manager uses a weighted evaluation for the at least one metric. The customer defines a metric that is weighted more heavily than other metrics associated with the at least one metric. So, the customer can control the suggestions based on preferences of the customer.

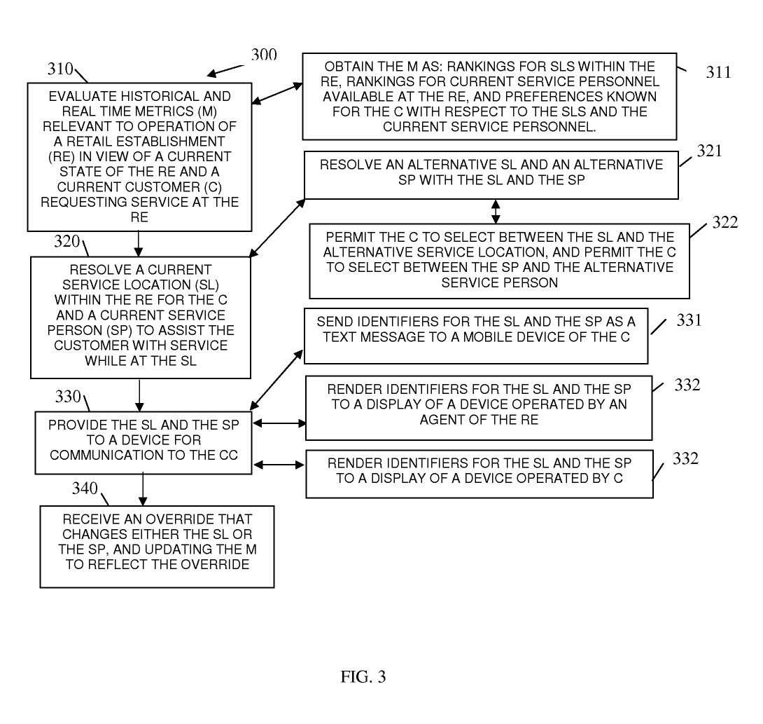

FIG. 3 is a diagram of another method 300 for managing retail services, according to an example embodiment. The method 300 (hereinafter “retail service manager”) is implemented as instruction and programmed within memory or a non-transitory computer-readable (processor-readable) storage medium that executes on one or more processors of a device; the processors of the device are specifically configured to execute the retail service manager. The retail service manager may also be operational over one or more networks; the networks may be wired, wireless, or a combination of wired and wireless.

The retail service manager presents another and in some ways enhanced view of the retail suggestion manager presented above with reference to the method 200 of the FIG. 2.

In an embodiment, the retail service manager is the service manager 121 of the FIG. 1.

In an embodiment, the retail service manager is the service manager 131 of the FIG. 1.

In an embodiment, the retail service manager is the service manager 141 of the FIG. 1.

In an embodiment, the retail service manager is a combination of the service managers 121, 131, and 141 of the FIG. 1.

At 310, the retail service manager evaluates historical and real time metrics relevant to operation of a retail establishment in view of a current operational state of the retail establishment and a current customer requesting service at the retail establishment.

In an embodiment, at 311, the retail service manager obtains the metrics (historical and real time) for the current service locations within the retail establishment for current service personnel available at the retail establishment, and the retail service manager obtains preferences known for the current customer with respect to the current service locations and the current service personnel.

At 320, the retail service manager resolves a current service location within the retail establishment and a current service person to assist the current customer with service while at the current service location.

In an embodiment, at 321, the retail service manager resolves an alternative service location and an alternative service person with the current service location and the current service person.

In an embodiment of 321 and at 322, the retail service manager permits the current customer to select between the current service location and the alternative service location, and the retail service manager permits the current customer to select between the current service person and the alternative service person.

In an embodiment, selections made by the customer in 322 can be recorded and retained in the metrics such that the preferences when the same or similar options are subsequently presented to the same customer, the retail service manager can select what the customer is known to have chosen before. In this way, using the metrics, the retail service manager can learn the likes and dislikes of the customer.

At 330, the retail service manager provides the current service location and the current service person to a device for communication to the current customer. This can be done in a variety of manners.

For example, at 331, the retail service manager sends identifiers for the current service location and the current service person as a text message to a mobile device of the current customer.

In another case, at 332, the retail service manager renders identifiers for the current service location and the current service person to a display of a device, which is operated by an agent of the retail establishment. The agent then verbally makes the suggestions for the current service location and the current service person to the current customer.

In yet another situation, at 333, the retail service manager renders identifiers for the current service location and the current service person to a display of a device operated by the current customer. This can be a customer owned device (such as a phone) or can be a retail establishment owned device (such as a kiosk).

In an embodiment, at 340, the retail service manager receives an override that changes either the current service location or the current service person, or both. In response to the override, the retail service manager updates the metrics to reflect the override, such that the retail service manager can learn to avoid such suggestions to this customer in the future and learns what the customer prefers while at the retail establishment.

In an embodiment, the agent or the customer (whoever initiated the initial request for the customer to receive service and though an agent or customer operated device) can make special requests (such as, “I am in a hurry with this appointment,” “I would like to order drinks or appetizer or place the order now,” “I am looking for a particular color sweater to buy in a medium,” etc. So, special requests can be made on behalf of the customer (by the agent or the customer) before the service actually starts.

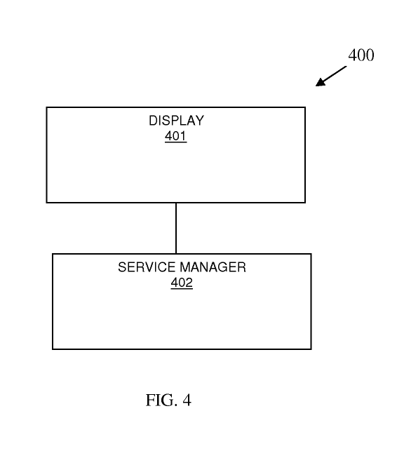

FIG. 4 is a diagram of a retail management system 400, according to an example embodiment. The components of the retail management system 400 are implemented as executable instructions and programmed within a non-transitory computer-readable (processor-readable) storage medium that execute on one or more processors of a device; the processors are specifically configured to execute the components of the retail management system 400. The retail management system 400 may also be operational over one or more networks; any such networks may be wired, wireless, or a combination of wired and wireless.

The retail management system 400 includes a display 401 and a service manager 402.

The display 401 is interfaced to the device, which executes the service manager 402. The device may be directly coupled to the display, such as is shown for the service manager 121 of the FIG. 1, or may be remotely interfaced to the device, such as is shown in the service managers 131 and 141 of the FIG. 1.

The service manager 402 is implemented in memory and/or a non-transitory computer-readable storage medium for execution on one or more processors of the device to which it is installed.

In an embodiment, the service manager 402 is the service manager 121 of the FIG. 1.

In an embodiment, the service manager 402 is the service manager 131 of the FIG. 1.

In an embodiment, the service manager 402 is the service manager 141 of the FIG. 1.

In an embodiment, the service manager 402 is a combination of the service managers 121, 131, and 141 of the FIG. 1.

In an embodiment, the service manager 402 is the method 200 of the FIG. 2.

In an embodiment, the service manager 402 is the method 300 of the FIG. 3.

The service manager 402 is configured and adapted to: execute on at least one processor; evaluate metrics relevant to a current state of a retail establishment; and present at least one suggestion on a screen rendered to the display 401. The at least one suggestion identifies a service location and a service person to assist a customer while at the retail establishment.

In an embodiment, the retail management system 400 is one of: a kiosk, a SST, a POS device, a networked terminal device, a tablet, a phone, a laptop, and a wearable processing device.

In an embodiment, the retail management system 400 is operated by one of: an agent of the retail establishment and the customer.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
obtaining at least one metric relevant to a state of a retail establishment;
suggesting at least one of: a service location for a customer and a service person to assist the customer based on evaluation of the at least one metric; and
presenting at least one of: the service location and an identifier for the service person in a screen rendered on a display.

2. The method of claim 1, wherein obtaining further includes receiving a request for a proposed service location and a proposed service person that initiates the obtaining of the at least one metric.

3. The method of claim 2, wherein receiving further includes acquiring the request from an agent of the retail establishment.

4. The method of claim 2, wherein receiving further includes acquiring the request from the customer.

5. The method of claim 2, wherein receiving further includes acquiring the request from an agent of the retail establishment, the agent enters the request into an agent device, the agent device one of: a terminal device, a Point-Of-Sale device, a tablet, a laptop, a phone, and a wearable processing device.

6. The method of claim 2, wherein receiving further includes acquiring the request from the customer, the customer enters the request into a device, the device one of: a kiosk, a Self-Service Terminal, a tablet, a laptop, a phone, and a wearable processing device.

7. The method of claim 1, wherein obtaining further includes acquiring the at least one metric from a local server that is local to the retail establishment.

8. The method of claim 1, wherein obtaining further includes acquiring the at least one metric from a remote server that is external and remote from the retail establishment.

9. The method of claim 1, wherein suggesting further includes using a weighted evaluation for the at least one metric, wherein a customer defined metric associated with the at least one metric is weighted more heavily than other metrics associated with the at least one metric.

10. A method, comprising:
evaluating historical and real time metrics relevant to operation of a retail establishment in view of a current state of the retail establishment and a current customer requesting service at the retail establishment;
resolving a current service location within the retail establishment for the current customer and a current service person to assist the customer with service while at the current service location; and
providing the current service location and the current service person to a device for communication to the current customer.

11. The method of claim 10, wherein evaluating further includes obtaining the historical and real time metrics as: rankings for current service locations within the retail establishment, rankings for current service personnel available at the retail establishment, and preferences known for the current customer with respect to the current service locations and the current service personnel.

12. The method of claim 10, wherein resolving further includes resolving an alternative service location and an alternative service person with the current service location and the current service person.

13. The method of claim 12, wherein providing permitting the current customer to select between the current service location and the alternative service location, and permitting the current customer to select between the current service person and the alternative service person.

14. The method of claim 10, wherein providing further includes sending identifiers for the current service location and the current service person as a text message to a mobile device of the current customer.

15. The method of claim 10, wherein providing further includes rendering identifiers for the current service location and the current service person to a display of a device operated by an agent of the retail establishment.

16. The method of claim 10, wherein providing further includes rendering identifiers for the current service location and the current service person to a display of a device operated by current customer.

17. The method of claim 10 further comprising, receiving an override that changes either the current service location or the current service person, and updating the real time metrics to reflect the override.

18. A system comprising:
a display; and
a service manager implemented in memory or in a non-transitory computer-readable storage medium, the service manager configured to: i) execute on at least one processor, ii) evaluate metrics relevant to a current state of a retail establishment, and iii) present at least one suggestion on a screen rendered to the display, the at least one suggestion identifies a service location and a service person to assist a customer while at the retail establishment.

19. The system of claim 18, wherein the system is one of: a kiosk, a Point-Of-Sale (POS) device, a Self-Service Terminal (SST), a networked terminal device, a tablet, a phone, a laptop, and a wearable processing device.

20. The system of claim 19, wherein the system is operated by one of: an agent of the retail establishment and the customer.
